(19) United States
(12) Patent Application Publication
(10) Pub. No.: US 2026/0087672 A1
(43) Pub. Date: Mar. 26, 2026

(54) MONOCULAR HIGH-SPEED VIDEOGRAMMETRY METHOD AND SYSTEM BASED ON DYNAMIC PLATFORM

(71) Applicants: Beijing University of Civil Engineering and Architecture, Beijing (CN); Beijing Institute of Engineering Geology, Beijing (CN)

(72) Inventors: Xianglei Liu, Beijing (CN); Yuqi Zhang, Beijing (CN); Runjie Wang, Beijing (CN); Yuxin Chen, Beijing (CN); Tao Yuan, Beijing (CN); Yike He, Beijing (CN); Jing Ma, Beijing (CN)

(21) Appl. No.: 19/324,200

(22) Filed: Sep. 10, 2025

(30) Foreign Application Priority Data
Sep. 25, 2024 (CN) 202411342779.5

(51) Int. Cl. G06T 7/80; G06T 3/4007; G06T 5/20; G06T 5/40; G06T 7/11; G06T 7/13; G06T 7/246; G06T 7/70

(52) U.S. Cl. CPC G06T 7/80; G06T 3/4007; G06T 5/20; G06T 5/40; G06T 7/11; G06T 7/13; G06T 7/246; G06T 7/70; G06T 2207/30244

(57) ABSTRACT

A monocular high-speed videogrammetry method based on a dynamic platform includes the following steps: collecting a monocular high-frame-rate image sequence of the dynamic platform and performing preprocessing; conducting dynamic image-block data processing on the image sequence based on adaptive brightness compensation and least-squares fitting (LSF) to obtain adjusted images; performing camera-pose calibration on the adjusted images based on sliding-window constraints to obtain calibrated images; and acquiring three-dimensional (3D) coordinates and estimated displacements of tracking points from the calibrated images, and outputting measurement results based on the 3D coordinates and the estimated displacements. Through optimization of the measurement process, the method supports real-time adaptive compensation, dynamic image-block processing, and camera-pose calibration, thereby providing significant application value. Correspondingly, the present disclosure also provides a monocular high-speed videogrammetry system based on a dynamic platform, which includes modules configured to implement the above steps.

### CROSS-REFERENCE TO RELATED APPLICATION

This application claims priority of Chinese Patent Application No. 202411342779.5, filed on Sep. 25, 2024, the entire contents of which are incorporated herein by reference.

### TECHNICAL FIELD

The present disclosure relates to the field of measurement, and in particular to a monocular high-speed videogrammetry method and system based on a dynamic platform.

### BACKGROUND

With the continuous advancement of global urbanization, public infrastructure has become an essential component of daily human activities. Nevertheless, routine usage and sudden natural or man-made disasters can induce cracking and spalling in such structures, thereby compromising their structural integrity and operational safety. Consequently, monitoring the seismic performance of public infrastructure is critical for mitigating casualties and reducing property losses. To this end, in the initial design phase of infrastructure, scaled vibration model tests are conducted on shaking tables to investigate the dynamic characteristics and responses of structures subjected to seismic and other dynamic loads.

When monocular measurement is conducted under the low-light conditions of a shaking table, supplemental illumination is essential for achieving accurate measurements within the wide field of view of a high-speed camera. However, achieving uniform illumination across the entire field of view remains challenging. The use of fill lights to partially illuminate artificial target points often leads to non-uniform illumination and degraded imaging quality at certain locations. Regions with weak light sources and limited fill-light coverage may result in insufficient illuminance, whereas sunlight or intense artificial lighting can cause overexposure. These issues blur the edges of target points and reduce the accuracy of geometric center estimation.

In addition, influenced by wind, gravity, and engine power, the dynamic platform remains in motion during measurement, resulting in changes in the pose of the high-speed camera. When the camera moves, the measured target displacement includes spurious components induced by camera motion, which significantly compromise the extraction of accurate displacement information. To eliminate the influence of dynamic platform motion, precise camera pose calibration is required for each frame.

To enable flexible and high-precision dynamic monitoring of the vibration behavior of long-span structures, the present disclosure provides a monocular high-speed videogrammetry method and system based on a dynamic platform. First, adaptive local contrast adjustment is performed to achieve robust and accurate sub-pixel center extraction for both low-illumination and overexposed targets. Second, wide-baseline dynamic calibration is performed, fully exploiting inter-frame geometric constraints to determine precise camera poses for each frame. Finally, three-dimensional (3D) structural information is reconstructed using the camera projection model, from which displacement data are derived.

### SUMMARY

An objective of the present disclosure is to provide a monocular high-speed videogrammetry method and system based on a dynamic platform.

To achieve the above objective, the present disclosure is implemented through the following technical solutions.

The method includes the following steps:
collecting a monocular high-frame-rate image sequence of the dynamic platform, and performing preprocessing on the image sequence;
performing dynamic image-block data processing on the image sequence based on adaptive brightness compensation and least-squares fitting (LSF) to obtain adjusted images, the dynamic image-block data processing sequentially including four steps: adaptive compensation of target points within image blocks, post-processing with Gaussian blur and adaptive-threshold binarization brightness compensation, LSF-based sub-pixel center localization of target points, and updating the image blocks and acquiring the target point centers of the image sequence;
performing camera-pose calibration on the adjusted images based on sliding-window constraints to obtain calibrated images, the camera-pose calibration sequentially including three steps: initial camera-pose estimation using the efficient perspective-n-point (EPnP) algorithm, optimization to minimize the re-projection error, and inter-sequence adjustment within the sliding window; and
acquiring 3D coordinates and estimated displacements of tracking points from the calibrated images, and outputting measurement results based on the 3D coordinates and the estimated displacements.

Further, the adaptive compensation of target points in image blocks includes the steps of:
taking approximate central pixel coordinates of a tracking point of a first frame of the image sequence as I(x,y), and determining a range [(x−(n+m), x+(n+m)), (y−(n+m), y+(n+m))] of an image block by using an extended range pixel n;
setting a search radius to m, and setting a range of the image block as a search area of matching image blocks of subsequent frames;
dividing the target points into standard targets, dark targets and overexposed targets according to characteristics of targets in the image block, in which the standard targets are markers collected under normal lighting conditions, the dark targets are markers collected under dark conditions, and the overexposed targets are markers collected under sufficient lighting conditions;
determining empirical grayscale thresholds for the three types of target points based on comprehensive analysis, wherein the average grayscale level of the standard targets ranges from 80 to 200, the average grayscale level of the dark targets is less than 80, and the average grayscale level of the overexposed targets exceeds 200;
enhancing the brightness and contrast of the dark targets using a single-scale Retinex method, and decomposing the original image into an illumination image and a reflection image, expressed as:

$$S ( x , y ) = R ( x , y ) \cdot L ( x , y )$$

where a pixel value of the original image is S(x,y), a reflectivity is R(x,y), an illuminance is L(x,y), and an enhanced reflectivity is calculated:

$${R}_{enhanced} ( x , y ) = log ( 1 + R ( x , y ) )$$

where the enhanced reflectivity is R_{enhanced}, and an enhanced image is obtained according to the enhanced reflectivity and illuminance:

$${S}_{enhanced} ( x , y ) = {R}_{enhanced} ( x , y ) \cdot L ( x , y )$$

where the enhanced image is S_{enhanced}(x,y);
dividing, for the overexposure targets, an input image into M×N sub-images of equal size, a height by width of the whole image being H×W, and the number of sub-images being

$$( \frac{H}{M} ) \times ( \frac{W}{N} ) ;$$

calculating grayscale histograms of the sub-images and acquiring a contrast-limit threshold by grayscale stretching, wherein the gray level is truncated and the excess portions are evenly redistributed to other gray levels if the frequency of a gray level exceeds the contrast-limit threshold, expressed as:

$${H}^{′} ( k ) = \{ \begin{matrix}λ , if H ( k ) > λ \\ H ( k ) , otherwise\end{matrix}$$

where the contrast limit threshold is λ, the number of pixels of a k-th gray level is H(k), and the number of updated pixels of the k-th gray level is \acute{H}(k);
reallocating an extra part, expressed as:

$$Δ H = {\sum }_{k} ( H ( k ) - λ ) , for H ( k ) > λ$$

where the extra part is ΔH; and an additional frequency is calculated:

$${H}^{*} ( k ) = {H}^{′} ( k ) + \frac{Δ H}{L}$$

where an additional frequency of the k-th gray level is H*(k), and an upper limit of a gray range is L; and cumulative distribution of a truncated histogram is calculated:

$$CDF ( k ) = {\sum }_{i = 0}^{k} {H}^{*} ( i )$$

where a cumulative distribution of the k-th gray level is CDF(k), an additional frequency of an i-th gray level is H*(i), and an upper limit of the gray level is k; and
normalizing the cumulative distribution, expressed as:

$$C D {F}_{norm} ( k ) = \frac{C D F ( k ) - C D {F}_{min}}{M \cdot N - C D {F}_{min}} ( L - 1 )$$

where a minimum non-zero value of cumulative distribution function (CDF) is CDFₘᵢₙ, a height of the sub-image is M, and a width of the sub-image is N; and a gray value of an original sub-image is mapped to an enhanced gray value according to the normalized cumulative distribution:

$${{S}^{′}}_{t i l e} ( x , y ) = C D {F}_{min} ( {S}_{t i l e} ( x , y ) )$$

where a pixel value of the original sub-image is Sₜᵢₗₑ(x,y), and a pixel value of an enhanced sub-image is Śₜᵢₗₑ(x,y); and for a boundary area between adjacent sub-images, bilinear interpolation is used to achieve smooth transition, and an initial compensated image is obtained.
Further, the post-processing of Gaussian blur and adaptive threshold binarization brightness compensation includes the steps of:
using a Gaussian function as a convolution kernel, performing weighted averaging on pixels in the initial compensated image, and calculating two dimensional (2D) Gaussian values:

$$G ( x , y ) = \frac{1}{2 {πσ}^{2}} exp ( - \frac{{x}^{2} + {y}^{2}}{2 {σ}^{2}} )$$

where a coordinate relative to a center of the convolution kernel is (x,y), the 2D Gaussian function of the coordinates is G(x,y), and a standard deviation of Gaussian distribution is σ;
obtaining a convolution kernel by discretizing the Gaussian function, and performing convolution on the image using the convolution kernel; and
adopting an adaptive thresholding method based on neighborhood means to determine the threshold value of each pixel by averaging the grayscale values within a local region of the image block, and outputting a compensated image.
Further, the LSF-based sub-pixel center localization of target points, together with the updating of image blocks and the acquisition of target point centers in the image sequence, includes the following steps:
using the Canny operator to detect the edge points of a circle in the compensated image, and applying the LSF to fit an ellipse center for sub-pixel localization, the ellipse equation being expressed as:

$$\frac{{( x - {x}_{c} )}^{2}}{{a}^{2}} + \frac{{( y - {y}_{c} )}^{2}}{{b}^{2}} = 1$$

where a central coordinate of the ellipse is (x_{c},y_{c}), a major axis of the ellipse is a, and a minor axis of the ellipse is b; and
a set of pixels on an edge of the ellipse is M=[(x₁,y₁), (x₂,y₂), . . . , (xₙ,yₙ)]; and a root mean square error (RMSE) is calculated:

$${ε}^{2} = {{\sum }_{i = 1}^{n} [ \frac{{( x - {x}_{c} )}^{2}}{{a}^{2}} + \frac{{( y - {y}_{c} )}^{2}}{{b}^{2}} - 1 ]}^{2}$$

$${x}_{s t , c} = \frac{max ( {x}_{i} ) + min ( {x}_{i} )}{2}$$

$${y}_{s t , c} = \frac{max ( {y}_{i} ) + min ( {y}_{i} )}{2}$$

where an initial center coordinate of the ellipse is (x_{st,c},y_{st,c}), an initial length of the major axis is

$${a}_{o} = \frac{max ( {x}_{i} ) - min ( {x}_{i} )}{2} ,$$

and an initial length of the minor axis is

$${b}_{o} = \frac{max ( {y}_{i} ) - min ( {y}_{i} )}{2} ;$$

using Levenberg-Marquardt method for nonlinear optimization based on the RMSE, and calculating an ellipse center I_{c}(x_{c},y_{c}) with sub-pixel accuracy; and
taking an integer part of I_{c}(x_{c},y_{c}) as an initial center approximate pixel coordinate, repeating operation to calculate an accurate center approximate pixel coordinate of a next frame tracking target, and outputting a compensated image after the accurate center approximate pixel coordinate as the adjusted image.
Further, the initial camera-pose estimation based on the EPnP algorithm includes the following steps:
estimating the initial camera pose of the frame using the EPnP algorithm, the projection model of the 3D points being expressed as:

$${p}_{i} = K [ R / T ] {P}_{i}$$

where K is a camera intrinsic matrix, R is a rotation matrix, T is a translation vector, and a 2D coordinate of an i-th frame control point is pᵢ;
using four virtual control points to represent all 3D points, as employed in EPnP:

$${P}_{i} = {\sum }_{j = 1}^{4} {a}_{i j} {C}_{j}$$

where

$${\sum }_{j = 1}^{4} {a}_{i j} = 1 ,$$

all JD points of an i-th control point are Pᵢ, a j-th frame weight coefficient of the i-th control point is aᵢⱼ, and a j-th virtual control point is Cⱼ; and a projection of the control point on an adjusted image plane being expressed as:

$${c}_{i} = K [ R / T ] {C}_{i}$$

where the i-th control point of the control point on the adjustment image plane is projected as cᵢ; and a linear equation is obtained by representing the 3D points as a linear combination of control points, expressed as:

$${p}_{i} = K [ T ] ( {\sum }_{j = 1}^{4} {a}_{ij} {C}_{j} ) = {\sum }_{j = 1}^{4} {a}_{ij} {c}_{j}$$

transforming the linear equation into a linear least squares problem, and solving for R and T.

Further, the optimization for minimizing re-projection error and the inter-sequence adjustment of the sliding window include the steps of:
combining the EPnP algorithm with the Levenberg-Marquardt nonlinear optimization algorithm, and using results of the EPnP algorithm as initial values to calculate a minimized re-projection error:

$$error = {\sum }_{i = 1}^{n} {‖ {p}_{i} - {\hat{p}}_{i} ‖}^{2}$$

where an actual 2D coordinate of the i-th control point is pᵢ, and an i-th 2D coordinate of a currently estimated external parameter projected from the 3D points is \hat{p}ᵢ;
iteratively adjusting the camera pose until the re-projection error converges to its minimum;
applying sliding-window adjustment to optimize the camera pose with inter-frame information, and selecting the sliding-window size N according to accuracy and efficiency requirements;
performing triangulation for each control point in the field of view using the camera-pose information from each frame pair within the window, calculating the corresponding 3D coordinates, and adjusting the error function, expressed as:

$$error = {\sum }_{i = t - N + 1}^{t} {\sum }_{j = 1}^{M} {‖ {X}_{i , j} - {\hat{X}}_{i , j} ‖}^{2}$$

where a true 3D coordinate of the i-th control point in the j-th frame is X_{i,j}, and a 3D coordinate estimated by triangulation is \hat{X}_{i,j}; and
applying the Levenberg-Marquardt algorithm to minimize the error function, sliding the window forward by one frame, repeating bundle adjustment optimization until all frames of the adjusted images have been processed, and outputting the calibrated images.
Further, the acquisition of 3D coordinates and estimated displacements of tracking points from the calibrated images includes the following steps:
reconstructing spatial positions of the tracking points in the calibrated images within a camera field of view based on a camera projection model, and converting 2D coordinates (u,v) into normalized camera coordinates (x_{c},y_{c},z_{c}), expressed as:

$$( {x}_{c} , {y}_{c} , {z}_{c} ) = s \cdot {K}^{- 1} \cdot ( u , v , 1 )$$

where the camera intrinsic matrix is K; and a relationship between pixel coordinates and real-world coordinates is established according to a scale factor, expressed as:

$$s = \frac{{d}_{w}}{{d}_{p}}$$

where the scale factor is s, an actual physical size of a measurement target surface is d_{w}, and a corresponding pixel size on an image plane is dₚ;
converting normalized camera coordinates to world coordinates:

$$( X , Y , Z ) = R \cdot ( {x}_{c} , {y}_{c} , {z}_{c} ) + T$$

where R is the rotation matrix and T is the translation vector; and displacements of corresponding tracking points are calculated in three directions:

$$\{ \begin{matrix}{S}_{{X}_{n}} = {X}_{n} - {X}_{1} \\ {S}_{{Y}_{n}} = {Y}_{n} - {Y}_{1} \\ {S}_{{Z}_{n}} = {Z}_{n} - {Z}_{1}\end{matrix}$$

where coordinates of the tracking point of the first frame in X, Y, and Z directions are X₁, Y₁ and Z₁, and coordinates of the corresponding points of the n-th frame in the X, Y, and Z directions are Xₙ, Yₙ and Zₙ; and
determining vibration state and maximum amplitude of a target structure under load based on dynamic displacements, and outputting 3D coordinates of the tracking points and the estimated displacements.

According to a second aspect, A monocular high-speed videogrammetry system based on a dynamic platform includes:
a data collection module, configured to collect a monocular high frame rate image sequence of a dynamic platform, and preprocess the image sequence;
an image block processing module, configured to perform dynamic image block data processing on the image sequence based on adaptive brightness compensation and LSF to obtain adjusted images; and the dynamic image block data processing sequentially including four steps: adaptive compensation of target points in image blocks, post-processing of Gaussian blur and adaptive threshold binarization brightness compensation, LSF-based sub-pixel center localization of target points, as well as update of the image blocks and acquisition of a target point center of the image sequence;
a pose-calibration module, configured to perform camera-pose calibration on the adjusted images based on sliding-window constraints to obtain calibrated images, the camera-pose calibration sequentially including three steps: initial camera-pose estimation using the EPnP algorithm, optimization to minimize the re-projection error, and inter-sequence adjustment within the sliding window; and
a measurement output module, configured to acquire 3D coordinates and estimated displacements of tracking points according to the calibrated images, and output measurement results according to the 3D coordinates and the estimated displacements.

The present disclosure provides the following advantageous effects.

The present disclosure provides a monocular high-speed videogrammetry method and system based on a dynamic platform, which yields the following technical effects compared with the related art.

In the present disclosure, through a series of key steps-including preprocessing, adaptive brightness compensation, dynamic image-block processing, camera-pose calibration, 3D coordinate acquisition, and displacement retrieval—the precision and reliability of monocular high-speed videogrammetry on a dynamic platform are significantly enhanced. By optimizing the measurement process, resource consumption is greatly reduced and overall efficiency is improved. This method enables automatic measurement of monocular high-speed video on a dynamic platform, supports real-time adaptive compensation, dynamic image-block processing, and camera-pose calibration, and provides important application value. Owing to its wide applicability, the method can meet the requirements of monocular high-speed videogrammetry for various types and standards of mobile platforms, demonstrating strong universality and practicality.

### BRIEF DESCRIPTION OF THE DRAWINGS

FIG. 1 is a flow chart of a monocular high-speed videogrammetry method and system based on a dynamic platform of the present disclosure;

FIG. 2 is a schematic diagram of a bridge structure and layout of tracking points;

FIG. 3 is a schematic diagram of layout of control points;

FIG. 4 is a comparison diagram of adaptive brightness compensation results before and after;

FIG. 5 is a schematic diagram of a sliding window;

FIG. 6 is a schematic diagram of positions of a camera;

FIG. 7 is a displacement curve of a tracking point 1;

FIG. 8 is a displacement curve of a tracking point 2;

FIG. 9 is a displacement curve of a tracking point 3;

FIG. 10 is a displacement curve of a tracking point 4; and

FIG. 11 is a comparison chart between measurement results of a monocular high-speed video of a dynamic platform and results of a displacement meter.

### DETAILED DESCRIPTION

The present disclosure will be further described below by way of specific examples, and the exemplary examples and descriptions of the present disclosure herein are intended to explain the present disclosure, but are not intended to limit the present disclosure.

The present disclosure provides a monocular high-speed videogrammetry method and system based on a dynamic platform, including the following steps.

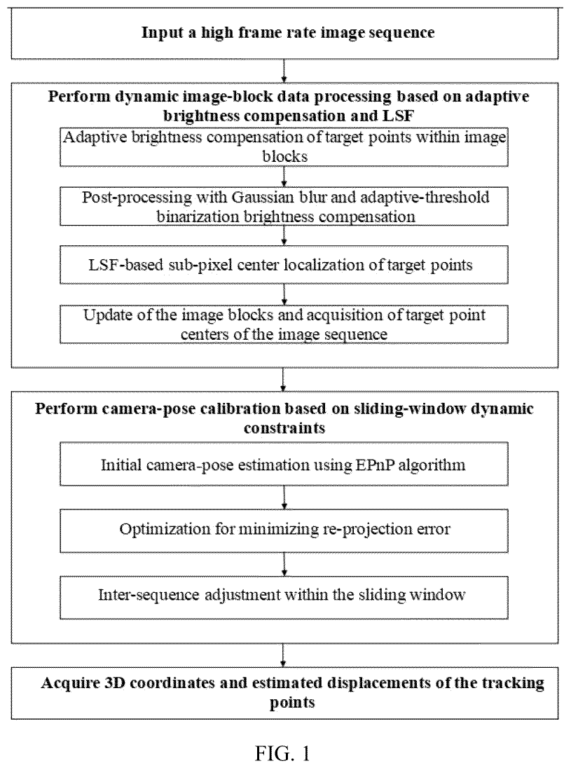

As shown in FIG. 1, in this example, the following steps are included.

A monocular high frame rate image sequence of a dynamic platform is collected, and the image sequence is preprocessed.

In the actual evaluation, the second connection of Bridge No. 2 on an interchange ramp is selected as the engineering background. The curvature radius of an urban ramp bridge typically ranges from 40 m to 60 m. The design of this bridge adopts a circular curve with a curvature radius of 50 m, with a span arrangement of 4×20 m. The main girder has a single-box single-cell cross-section, and the bridge piers are solid reinforced-concrete cylindrical piers.

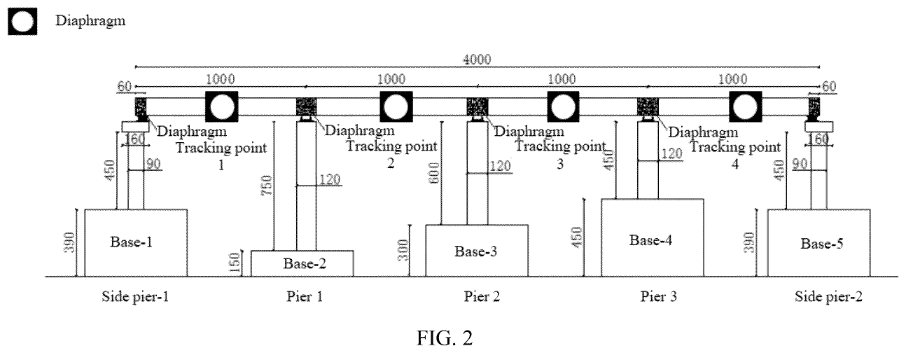

Artificial target points, used as observation points, can significantly improve the accuracy of videogrammetry and the efficiency of target tracking, and are often affixed to the surface of the measured object. In this experiment, artificial target points are divided into control points and tracking points. The control points are used to determine the external orientation parameters of two cameras, while the tracking points are used to measure dynamic changes in the observed positions on the target. Each tracking point is marked by a white circle with a black border. Each control point includes a cross wire and an inner circle, designed to enable measurement of its 3D coordinates using a total station. According to the experimental scene and the size of the structural model, the diameter of each artificial circular target is 7 cm, and the 3D coordinates of the centers of the control points are obtained using a high-precision total station. A schematic diagram of the bridge structure and the layout of tracking points is shown in FIG. 2, and a schematic diagram of the layout of control points is shown in FIG. 3. This example aims to investigate the dynamic characteristics of the ramp bridge under seismic loading. Key nodes of the ramp bridge are monitored to assess the impact of seismic waves on the structural model. Particular attention is given to the deformation of joints between the bridge piers and the bridge deck during seismic activity. Target points are placed at key nodes of the structural model, and control networks are evenly distributed around the shaking table to calibrate the dynamic platform of the high-speed videogrammetry system. In addition, a near-field natural Chi-Chi wave is adopted as the input waveform, with a specified peak value and duration applied on the shaking table.

Dynamic image-block data processing is performed on the image sequence based on adaptive brightness compensation and LSF to obtain adjusted images; the dynamic image-block data processing sequentially includes four steps: adaptive compensation of target points within image blocks, post-processing with Gaussian blur and adaptive-threshold brightness compensation, LSF-based sub-pixel center localization of target points, and updating the image blocks with acquisition of the target point centers of the image sequence.

Camera-pose calibration is performed on the adjusted images based on sliding-window constraints to obtain calibrated images; the camera-pose calibration sequentially includes three steps: initial camera-pose estimation using the EPnP algorithm, optimization to minimize the re-projection error, and inter-sequence adjustment within the sliding window.

3D coordinates and estimated displacements of tracking points are acquired from the calibrated images, and measurement results are output based on the 3D coordinates and the estimated displacements.

In this example, the adaptive compensation of target points in image blocks includes the following steps.

An approximate central pixel coordinate of a tracking point of a first frame of the image sequence is taken as I(x,y), and a range [(x−(n+m), x+(n+m)), (y−(n+m), y+(n+m))] of an image block is determined by using an extended range pixel n.

A search radius is set to m, and a range of the image block is set as a search area of matching image blocks of subsequent frames.

The target points are classified into standard targets, dark targets, and overexposed targets according to their characteristics within the image block. Standard targets are markers acquired under normal lighting conditions, dark targets are markers acquired under low-light conditions, and overexposed targets are markers acquired under strong-light conditions.

Empirical grayscale thresholds for the three types of target points are determined based on comprehensive analysis: the average grayscale level of the standard targets ranges from 80 to 200, the average grayscale level of the dark targets is less than 80, and the average grayscale level of the overexposed targets exceeds 200.

The brightness and contrast of the dark targets are enhanced using a single-scale Retinex method, and the original image is decomposed into an illumination image and a reflection image, expressed as:

$$S ( x , y ) = R ( x , y ) \cdot L ( x , y )$$

where a pixel value of the original image is S(x,y), a reflectivity is R(x,y), and an illuminance is L(x,y), and an enhanced reflectivity is calculated:

$${R}_{enhanced} ( x , y ) = log ( 1 + R ( x , y ) )$$

where the enhanced reflectivity is R_{enhanced}, and an enhanced image is obtained according to the enhanced reflectivity and the illuminance:

$${S}_{enhanced} ( x , y ) = {R}_{enhanced} ( x , y ) \cdot L ( x , y )$$

where the enhanced image is S_{enhanced}(x,y);
for the overexposure targets, an input image into M×N is divided sub-images of equal size, a height by width of the whole image is H×W, and the number of sub-images is

$$( \frac{H}{M} ) \times ( \frac{W}{N} ) .$$

Gray histograms of the sub-images are calculated, and a contrast limit threshold is acquired by gray stretching; and the gray level is cut and excess parts are evenly redistributed to other gray levels if a frequency of a gray level exceeds the contrast limit threshold; and an expression is expressed as:

$${H}^{′} ( k ) = \{ \begin{matrix}λ , if H ( k ) > λ \\ H ( k ) , otherwise\end{matrix}$$

where the contrast limit threshold is λ, the number of pixels of a k-th gray level is H(k), and the number of updated pixels of the k-th gray level is \acute{H}(k).

An extra part is reallocated, and an expression is expressed as:

$$Δ H = {\sum }_{k} ( H ( k ) - λ ) , for H ( k ) > λ$$

where the extra part is ΔH; and calculating an additional frequency:

$${H}^{*} ( k ) = {H}^{′} ( k ) + \frac{Δ H}{L}$$

where an additional frequency of the k-th gray level is H*(k), and an upper limit of a gray range is L; and calculating cumulative distribution of a truncated histogram:

$$CDF ( k ) = {\sum }_{i = 0}^{k} {H}^{⋆} ( i )$$

where a cumulative distribution of the k-th gray level is CDF(k), an additional frequency of an i-th gray level is H*(i), and an upper limit of the gray level is k.

The cumulative distribution is normalized, and an expression is expressed as:

$$C D {F}_{norm} ( k ) = \frac{C D F ( k ) - C D {F}_{min}}{M \cdot N - C D {F}_{min}} ( L - 1 )$$

where a minimum non-zero value of CDF is CDFₘᵢₙ, a height of the sub-image is M, and a width of the sub-image is N; and a gray value of an original sub-image is mapped to an enhanced gray value according to the normalized cumulative distribution:

$${{S}^{′}}_{t i l e} ( x , y ) = C D {F}_{min} ( {S}_{t i l e} ( x , y ) )$$

where a pixel value of the original sub-image is Sₜᵢₗₑ(x,y), and a pixel value of an enhanced sub-image is Śₜᵢₗₑ(x,y); and for a boundary area between adjacent sub-images, bilinear interpolation is used to achieve smooth transition, and an initial compensated image is obtained.

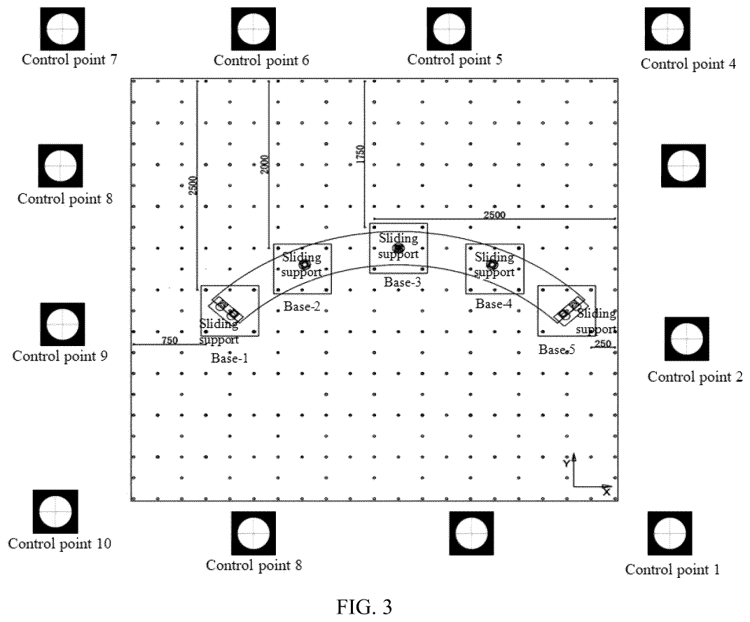

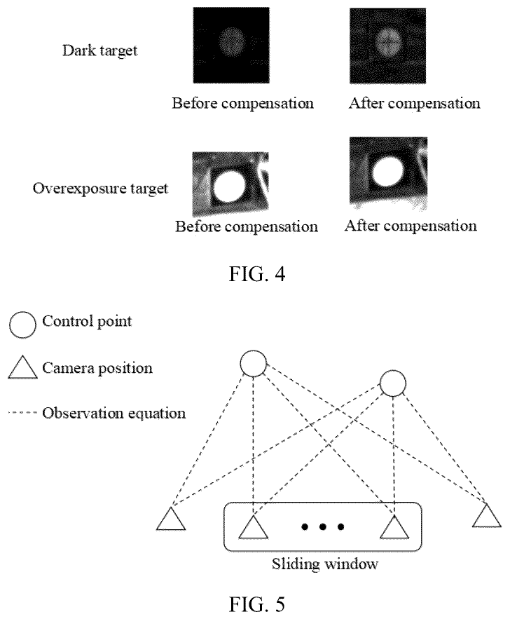

FIG. 4 shows adaptive brightness compensation results of dark target points and overexposed target points in the image block in this example.

In this example, the post-processing of Gaussian blur and adaptive threshold binarization brightness compensation includes the following steps.

A Gaussian function is used as a convolution kernel, weighted averaging is performed on pixels in the initial compensated image, and 2D Gaussian values are calculated:

$$G ( x , y ) = \frac{1}{2 {πσ}^{2}} exp ( - \frac{{x}^{2} + {y}^{2}}{2 {σ}^{2}} )$$

where a coordinate relative to a center of the convolution kernel is (x,y), the 2D Gaussian function of the coordinates is G(x,y), and a standard deviation of Gaussian distribution is σ.

A convolution kernel is obtained by discretizing the Gaussian function, the convolution kernel is applied to convolve the image, and an adaptive-threshold calculation method based on neighborhood means is adopted to determine the threshold value of each pixel by averaging the grayscale values within a local region of the image block, thereby achieving binarization of local features.

An adaptive-threshold method based on neighborhood means is used to determine the threshold value of each pixel by averaging the grayscale values within a local region of the image block, and a compensated image is output.

In this example, the LSF-based sub-pixel center localization of target points, together with the updating of image blocks and the acquisition of target point centers in the image sequence, includes the following steps.

The Canny operator is used to identify edge points of a circle in the compensated image, and the LSF is utilized to fit a center of an ellipse for subpixel localization, an ellipse equation is expressed as:

$$\frac{{( x - {x}_{c} )}^{2}}{{a}^{2}} + \frac{{( y - {y}_{c} )}^{2}}{{b}^{2}} = 1$$

where a central coordinate of the ellipse is (x_{c},y_{c}), a major axis of the ellipse is a, and a minor axis of the ellipse is b; and
a set of pixels on an edge of the ellipse is M=[(x₁,y₁), (x₂,y₂), . . . , (xₙ,yₙ)]; and a RMSE is calculated:

$${ε}^{2} = {{\sum }_{i = 1}^{n} [ \frac{{( x - {x}_{c} )}^{2}}{{a}^{2}} + \frac{{( y - {y}_{c} )}^{2}}{{b}^{2}} - 1 ]}^{2}$$

$${x}_{s t , c} = \frac{max ( {x}_{i} ) + min ( {x}_{i} )}{2}$$

$${y}_{s t , c} = \frac{max ( {y}_{i} ) + min ( {y}_{i} )}{2}$$

where an initial center coordinates of the ellipse is (x_{st,c},y_{st,c}), an initial length of the major axis is

$${a}_{o} = \frac{max ( {x}_{i} ) - min ( {x}_{i} )}{2} ,$$

and an initial length of the minor axis is major axis is

$${b}_{o} = \frac{max ( {y}_{i} ) - min ( {y}_{i} )}{2} .$$

Levenberg-Marquardt method is used for nonlinear optimization based on the RMSE, and an ellipse center I_{c}(x_{c},y_{c}) with sub-pixel accuracy is calculated.

An integer part of I_{c}(x_{c},y_{c}) is taken as an initial center approximate pixel coordinate, operation is repeated to calculate an accurate center approximate pixel coordinate of a next frame tracking target, and a compensated image after the accurate center approximate pixel coordinate is outputted as the adjusted image.

In this example, the initial camera pose estimation based on EPnP includes the following steps.

An initial camera pose of the frame is estimated using the EPnP algorithm, and a projection model expression of 3D points is expressed as:

$${p}_{i} = K [ R / T ] {P}_{i}$$

where K is a camera intrinsic matrix, R is a rotation matrix, T is a translation vector, and a 2D coordinate of an i-th frame control point is pᵢ.

Four virtual control points are used to represent all 3D points, as employed in EPnP:

$${P}_{i} = {\sum }_{j = 1}^{4} {a}_{i j} {C}_{j}$$

where

$${\sum }_{j = 1}^{4} {a}_{i j} = 1 ,$$

all DD points of an i-th control point are Pᵢ, a j-th frame weight coefficient of the i-th control point is aᵢⱼ, and a j-th virtual control point is Cⱼ; and a projection of the control point on an adjusted image plane is expressed as:

$${c}_{i} = K [ R / T ] {C}_{i}$$

where the i-th control point of the control point on the adjustment image plane is projected as cᵢ; and a linear equation is obtained by representing the 3D points as a linear combination of control points, expressed as:

$${p}_{i} = K [ T ] ( {\sum }_{j = 1}^{4} {a}_{i j} {C}_{j} ) = {\sum }_{j = 1}^{4} {a}_{i j} {c}_{j}$$

The linear equation is transformed into a linear least squares problem, and R and T are solved.

In this example, the optimization for minimizing re-projection error and the inter-sequence adjustment of the sliding window includes the following steps.

The EPnP algorithm is combined with the Levenberg-Marquardt nonlinear optimization algorithm, and results of the EPnP algorithm are used as initial values to calculate a minimized re-projection error:

$$error = {\sum }_{i = 1}^{n} {‖ {p}_{i} - {\hat{p}}_{i} ‖}^{2}$$

where an actual 2D coordinate of the i-th control point is pᵢ, and an i-th 2D coordinate of a currently estimated external parameter projected from the 3D points is \hat{p}ᵢ.

The camera pose is gradually adjusted until the minimized re-projection error converges to a minimum.

As shown in FIG. 5, sliding window adjustment is used to optimize the camera pose by using inter-frame information, and a size of a sliding window N is selected based on accuracy and efficiency requirements.

Triangulation is performed for each control point in the field of view using the camera pose information in each pair of frames in the window, and 3D coordinates thereof are calculated, an error function is adjusted, and an expression is expressed as:

$$error = {\sum }_{i = t - N + 1}^{t} {\sum }_{j = 1}^{M} {‖ {X}_{i , j} - {\hat{X}}_{i , j} ‖}^{2}$$

where a true 3D coordinate of the i-th control point in the j-th frame is X_{i,j}, and a 3D coordinate estimated by triangulation is \hat{X}_{i,j}.

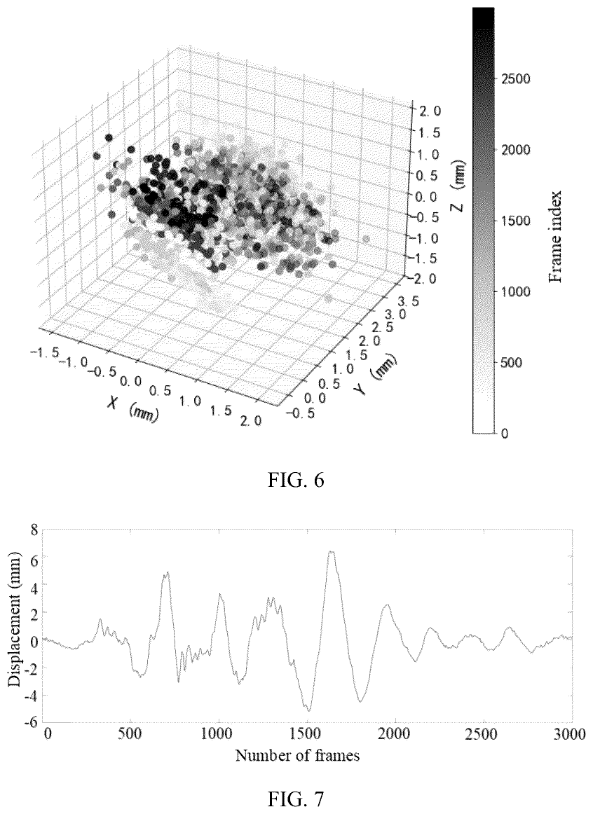

The Levenberg-Marquardt algorithm is used to minimize the error function, the window is slid forward one frame, bundle adjustment optimization is repeated until all frames of the adjusted images are traversed, and calibrated camera pose information is outputted. In this example, the generated camera position information is shown in FIG. 6.

In this example, the acquiring 3D coordinates and estimated displacements of tracking points according to the calibrated images includes the following steps.

Spatial positions of the tracking points in the calibrated images within a camera field of view are reconstructed based on a camera projection model, 2D coordinates (u,v) are converted into normalized camera coordinates (x_{c},y_{c},z_{c}), and an expression is expressed as:

$$( {x}_{c} , {y}_{c} , {z}_{c} ) = s \cdot {K}^{- 1} \cdot ( u , v , 1 )$$

where the camera intrinsic matrix is K; and a relationship between pixel coordinates and real-world coordinates is established according to a scale factor, and an expression is expressed as:

$$s = \frac{{d}_{w}}{{d}_{p}}$$

where the scale factor is s, an actual physical size of a measurement target surface is d_{w}, and a corresponding pixel size on an image plane is dₚ.

Normalized camera coordinates are converted to world coordinates:

$$( X , Y , Z ) = R \cdot ( {x}_{c} , {y}_{c} , {z}_{c} ) + T$$

where R is the rotation matrix and T is the translation vector; and displacements of corresponding tracking points are calculated in three directions:

$$\{ \begin{matrix}{S}_{{X}_{n}} = {X}_{n} - {X}_{1} \\ {S}_{{Y}_{n}} = {Y}_{n} - {Y}_{1} \\ {S}_{{Z}_{n}} = {Z}_{n} - {Z}_{1}\end{matrix}$$

where coordinates of the tracking point of the first frame in X, Y, and Z directions are X₁, Y₁ and Z₁, and coordinates of the corresponding points of the n-th frame in the X, Y, and Z directions are Xₙ, Yₙ and Zₙ.

Vibration state and maximum amplitude of a target structure are determined under load based on dynamic displacements, and 3D coordinates of the tracking points and the estimated displacements are outputted.

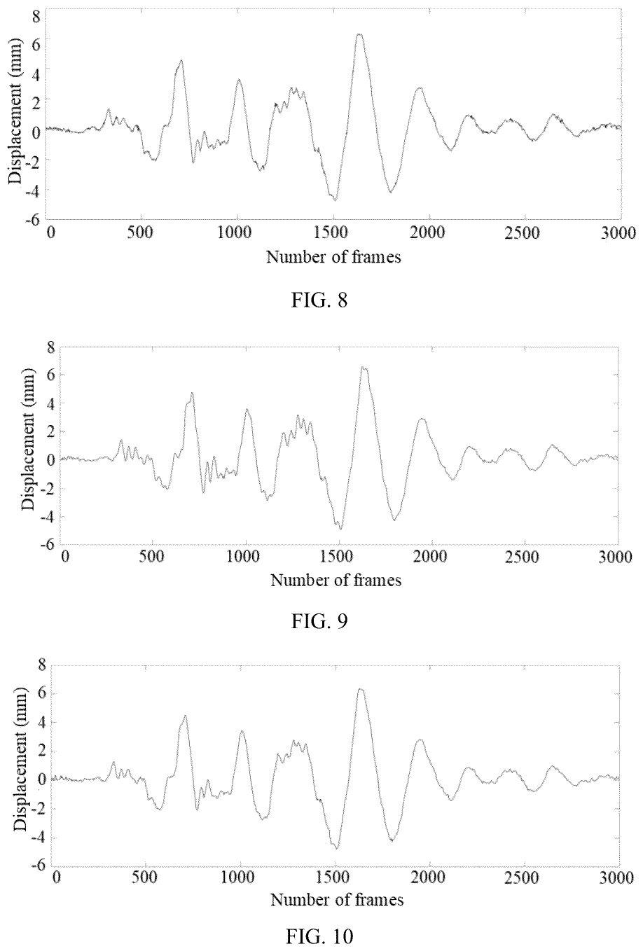

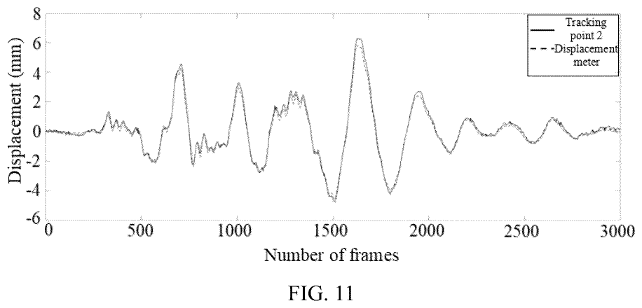

In this example, displacements of the tracking points 1-4 in the seismic wave input direction is shown in FIGS. 7-10. At the same time, the displacement meter arranged at the tracking point 2 is compared with the measurement results of the this example, and the measurement accuracy of the adopted displacement meter can reach 0.1 mm, which can be used as a reference for the displacement value. The comparison results are shown in FIG. 11.

According to a second aspect, a monocular high-speed videogrammetry system based on a dynamic platform includes:
a data collection module, configured to collect a monocular high frame rate image sequence of a dynamic platform, and preprocess the image sequence;
an image-block processing module, configured to perform dynamic image-block data processing on the image sequence based on adaptive brightness compensation and LSF to obtain adjusted images, the dynamic image-block data processing sequentially including four steps: adaptive compensation of target points within image blocks, post-processing with Gaussian blur and adaptive-threshold binarization brightness compensation, LSF-based sub-pixel center localization of target points, and updating the image blocks while acquiring the target point centers of the image sequence;
an pose calibration module, configured to perform camera pose calibration on the adjusted images based on dynamic constraint of a sliding window to obtain calibrated images; and the camera pose calibration sequentially including three steps: initial camera pose estimation based on EPnP, optimization for minimizing re-projection error, and sliding-window inter-frame adjustment; and
a measurement output module, configured to acquire 3D coordinates and estimated displacements of tracking points according to the calibrated images, and output measurement results according to the 3D coordinates and the estimated displacements.

The above description is merely a preferred example of the present disclosure and is not intended to limit the present disclosure. Any modifications, equivalent replacements, and improvements made within the spirit and principles of the present disclosure are to be included within the protection scope of the present disclosure.

1. A monocular high-speed videogrammetry method based on a dynamic platform, comprising the steps of:
collecting a monocular high-frame-rate image sequence of the dynamic platform and performing preprocessing on the image sequence;
performing dynamic image-block data processing on the image sequence based on adaptive brightness compensation and least-squares fitting (LSF) to obtain adjusted images, the dynamic image-block data processing sequentially comprising four steps: adaptive compensation of target points within image blocks, post-processing with Gaussian blur and adaptive-threshold binarization brightness compensation, LSF-based sub-pixel center localization of target points, and updating the image blocks while acquiring the target point centers of the image sequence;
performing camera-pose calibration on the adjusted images based on sliding-window constraints to obtain calibrated images, the camera-pose calibration sequentially comprising three steps: initial camera-pose estimation using the efficient perspective-n-point (EPnP) algorithm, optimization to minimize the re-projection error, and inter-sequence adjustment within the sliding window; and
acquiring three-dimensional (3D) coordinates and estimated displacements of tracking points from the calibrated images, and outputting measurement results based on the 3D coordinates and the estimated displacements.

2. The monocular high-speed videogrammetry method based on a dynamic platform according to claim 1, wherein the adaptive compensation of target points in image blocks comprises the steps of:
taking approximate central pixel coordinates of a tracking point of a first frame of the image sequence as I(x,y), and determining a range [(x−(n+m), x+(n+m)), (y−(n+m), y+(n+m))] of an image block by using an extended range pixel n;
setting a search radius to m, and setting a range of the image block as a search area of matching image blocks of subsequent frames;
dividing the target points into standard targets, dark targets and overexposed targets according to characteristics of targets in the image block, where the standard targets are markers collected under normal lighting conditions, the dark targets are markers collected under dark conditions, and the overexposed targets are markers collected under sufficient lighting conditions;
determining empirical grayscale thresholds for the three types of target points based on comprehensive analysis: the average grayscale level of the standard targets ranges from 80 to 200, the average grayscale level of the dark targets is less than 80, and the average grayscale level of the overexposed targets exceeds 200;
enhancing brightness and contrast of the dark targets based on single-scale Retinex, and decomposing an original image into an illumination image and a reflection image, expressed as:
$$S ( x , y ) = R ( x , y ) \cdot L ( x , y )$$
where a pixel value of the original image is S(x,y), a reflectivity is R(x,y), an illuminance is L(x,y), and an enhanced reflectivity is calculated:
$${R}_{enhanced} ( x , y ) = log ( 1 + R ( x , y ) )$$
where the enhanced reflectivity is R_{enhanced}, and an enhanced image is obtained according to the enhanced reflectivity and illuminance:
$${S}_{enhanced} ( x , y ) = {R}_{enhanced} ( x , y ) \cdot L ( x , y )$$
where the enhanced image is S_{enhanced}(x,y);
dividing, for the overexposure targets, an input image into M×N sub-images of equal size, a height by width of the whole image being H×W, and the number of sub-images being
$$( \frac{H}{M} ) \times ( \frac{W}{N} ) ;$$
calculating gray histograms of the sub-images, and acquiring a contrast limit threshold by gray stretching, the gray level being cut and excess parts being evenly redistributed to other gray levels if a frequency of a gray level exceeds the contrast limit threshold, expressed as:
$${H}^{′} ( k ) = \{ \begin{matrix}λ , if H ( k ) > λ \\ H ( k ) , otherwise\end{matrix}$$
where the contrast limit threshold is λ, the number of pixels of a k-th gray level is H(k), and the number of updated pixels of the k-th gray level is \acute{H}(k);
reallocating an extra part, expressed as:
$$Δ H = {\sum }_{k} ( H ( k ) - λ ) , for H ( k ) > λ$$
where the extra part is ΔH; and an additional frequency is calculated:
$${H}^{*} ( k ) = {H}^{′} ( k ) + \frac{Δ H}{L}$$
where an additional frequency of the k-th gray level is H*(k), and an upper limit of a gray range is L; and cumulative distribution of a truncated histogram is calculated:
$$CDF ( k ) = {\sum }_{i = 0}^{k} {H}^{*} ( i )$$
where a cumulative distribution of the k-th gray level is CDF(k), an additional frequency of an i-th gray level is H*(i), and an upper limit of the gray level is k; and
normalizing the cumulative distribution, expressed as:
$$C D {F}_{norm} ( k ) = \frac{CDF ( k ) - {CDF}_{min}}{M \cdot N - {CDF}_{min}} ( L - 1 )$$
where a minimum non-zero value of cumulative distribution function (CDF) is CDFₘᵢₙ, a height of the sub-image is M, and a width of the sub-image is N; and a gray value of an original sub-image is mapped to an enhanced gray value according to the normalized cumulative distribution:
$${{S}^{′}}_{tile} ( x , y ) = {CDF}_{min} ( {S}_{tile} ( x , y ) )$$
where a pixel value of the original sub-image is Sₜᵢₗₑ(x,y), and a pixel value of an enhanced sub-image is Śₜᵢₗₑ(x,y); and for a boundary area between adjacent sub-images, bilinear interpolation is used to achieve smooth transition, and an initial compensated image is obtained.

3. The monocular high-speed videogrammetry method based on a dynamic platform according to claim 1, wherein the post-processing of Gaussian blur and adaptive threshold binarization brightness compensation comprises the steps of:
using a Gaussian function as a convolution kernel, performing weighted averaging on pixels in the initial compensated image, and calculating two dimensional (2D) Gaussian values:
$$G ( x , y ) = \frac{1}{2 {πσ}^{2}} exp ( - \frac{{x}^{2} + {y}^{2}}{2 {σ}^{2}} )$$
where a coordinate relative to a center of the convolution kernel is (x,y), the 2D Gaussian function of the coordinates is G(x,y), and a standard deviation of Gaussian distribution is σ;
obtaining the convolution kernel by discretizing the Gaussian function, and performing convolution on an image using the convolution kernel; and
adopting an adaptive threshold method based on a neighborhood mean to determine a threshold value of each pixel by averaging gray values in a local area of the image block, and outputting a compensated image.

4. The monocular high-speed videogrammetry method based on a dynamic platform according to claim 1, wherein the LSF-based sub-pixel center localization of target points, as well as the update of the image blocks and acquisition of a target point center of the image sequence comprise the steps of:
using the Canny operator to identify edge points of a circle in the compensated image, and utilizing the LSF to fit a center of an ellipse for subpixel localization, an ellipse equation being expressed as:
$$\frac{{( x - {x}_{c} )}^{2}}{{a}^{2}} + \frac{{( y - {y}_{c} )}^{2}}{{b}^{2}} = 1$$
where a central coordinate of the ellipse is (x_{c},y_{c}), a major axis of the ellipse is a, and a minor axis of the ellipse is b; and
a set of pixels on an edge of the ellipse is M=[(x₁,y₁), (x₂,y₂), . . . , (xₙ,yₙ)]; and a root mean square error (RMSE) is calculated:
$${ε}^{2} = {\sum }_{i = 1}^{n} {[ \frac{{( x - {x}_{c} )}^{2}}{{a}^{2}} + \frac{{( y - {y}_{c} )}^{2}}{{b}^{2}} - 1 ]}^{2}$$
$${x}_{st , c} = \frac{max ( {x}_{i} ) + min ( {x}_{i} )}{2}$$
$${y}_{st , c} = \frac{max ( {y}_{i} ) + min ( {y}_{i} )}{2}$$
where an initial center coordinate of the ellipse is (x_{st,c},y_{st,c}), an initial length of the major axis is
$${a}_{o} = \frac{max ( {x}_{i} ) - min ( {x}_{i} )}{2} ,$$
and an initial length of the minor axis is
$${b}_{o} = \frac{max ( {y}_{i} ) - min ( {y}_{i} )}{2} ;$$
using Levenberg-Marquardt method for nonlinear optimization based on the RMSE, and calculating an ellipse center I_{c}(x_{c},y_{c}) with sub-pixel accuracy; and
taking an integer part of I_{c}(x_{c},y_{c}) as an initial center approximate pixel coordinate, repeating operation to calculate an accurate center approximate pixel coordinate of a next frame tracking target, and outputting a compensated image after the accurate center approximate pixel coordinate as the adjusted image.

5. The monocular high-speed videogrammetry method based on a dynamic platform according to claim 1, wherein the initial camera pose estimation based on EPnP comprises the steps of:
estimating an initial camera pose of the frame using the EPnP algorithm, a projection model expression of 3D points being:
$${p}_{i} = K [ R / T ] {P}_{i}$$
where K is a camera intrinsic matrix, R is a rotation matrix, T is a translation vector, and a 2D coordinate of an i-th frame control point is pᵢ;
using four virtual control points to represent all 3D points, as employed in EPnP:
$${P}_{i} = {\sum }_{j = 1}^{4} {a}_{ij} {C}_{j}$$
where
$${\sum }_{j = 1}^{4} {a}_{ij} = 1 ,$$
all 3D points of an 1-th control point are Pᵢ, a j-th frame weight coefficient of the i-th control point is aᵢⱼ, and a j-th virtual control point is Cⱼ; and a projection of the control point on an adjusted image plane being expressed as:
$${c}_{i} = K [ R / T ] {C}_{i}$$
where the i-th control point of the control point on the adjustment image plane is projected as cᵢ; and a linear equation is obtained by representing the 3D points as a linear combination of control points, expressed as:
$${p}_{i} = K [ R / T ] ( {\sum }_{j = 1}^{4} {a}_{ij} {C}_{j} ) = {\sum }_{j = 1}^{4} {a}_{ij} {c}_{j}$$
transforming the linear equation into a linear least squares problem, and solving for R and T.

6. The monocular high-speed videogrammetry method based on a dynamic platform according to claim 1, wherein the optimization for minimizing the re-projection error and the inter-sequence adjustment within the sliding window comprise the following steps:
combining the EPnP algorithm with the Levenberg-Marquardt nonlinear optimization algorithm, and using the results of the EPnP algorithm as initial values to calculate the minimized re-projection error:
$$error = {\sum }_{i = 1}^{n} {‖ {p}_{i} - {\hat{p}}_{i} ‖}^{2}$$
where an actual 2D coordinate of the i-th control point is pᵢ, and an i-th 2D coordinate of a currently estimated external parameter projected from the 3D points is \hat{p}ᵢ;
gradually adjusting the camera pose until the minimized re-projection error converges to a minimum;
using sliding window adjustment to optimize the camera pose by using inter-frame information, and selecting a size of a sliding window N based on accuracy and efficiency requirements;
performing triangulation for each control point in the field of view using the camera pose information in each pair of frames in the window, calculating 3D coordinates thereof, and adjusting an error function, expressed as:
$$error = {\sum }_{i = t - N + 1}^{t} {\sum }_{j = 1}^{M} {‖ {X}_{i , j} - {\hat{X}}_{i , j} ‖}^{2}$$
where a true 3D coordinate of the i-th control point in the j-th frame is X_{i,j}, and a 3D coordinate estimated by triangulation is \hat{X}_{i,j}; and
using the Levenberg-Marquardt algorithm to minimize the error function, sliding the window forward by one frame, repeating bundle adjustment optimization until all frames of the adjusted images are traversed, and outputting the calibrated images.

7. The monocular high-speed videogrammetry method based on a dynamic platform according to claim 1, wherein the acquiring 3D coordinates and estimated displacements of tracking points according to the calibrated images comprises the steps of:
reconstructing spatial positions of the tracking points in the calibrated images within a camera field of view based on a camera projection model, and converting 2D coordinates (u,v) into normalized camera coordinates (x_{c},y_{c},z_{c}), expressed as:
$$( {x}_{c} , {y}_{c} , {z}_{c} ) = s \cdot {K}^{- 1} \cdot ( u , v , 1 )$$
where the camera intrinsic matrix is K; and a relationship between pixel coordinates and real-world coordinates is established according to a scale factor, expressed as:
$$s = \frac{{d}_{w}}{{d}_{p}}$$
where the scale factor is s, an actual physical size of a measurement target surface is d_{w}, and a corresponding pixel size on an image plane is dₚ;
converting normalized camera coordinates to world coordinates:
$$( X , Y , Z ) = R \cdot ( {x}_{c} , {y}_{c} , {z}_{c} ) + T$$
where R is the rotation matrix and T is the translation vector; and displacements of corresponding tracking points are calculated in three directions:
$$\{ \begin{matrix}{S}_{{X}_{n}} = {X}_{n} - {X}_{1} \\ {S}_{{Y}_{n}} = {Y}_{n} - {Y}_{1} \\ {S}_{{Z}_{n}} = {Z}_{n} - {Z}_{1}\end{matrix}$$
where coordinates of the tracking point of the first frame in X, Y, and Z directions are X₁, Y₁ and Z₁, and coordinates of the corresponding points of the n-th frame in the X, Y, and Z directions are Xₙ, Yₙ and Zₙ; and
determining vibration state and maximum amplitude of a target structure under load based on dynamic displacements, and outputting 3D coordinates of the tracking points and estimated displacements.

8. A monocular high-speed videogrammetry system based on a dynamic platform, comprising:
a data-collection module, configured to collect a monocular high-frame-rate image sequence of the dynamic platform and to perform preprocessing on the image sequence;
an image-block processing module, configured to perform dynamic image-block data processing on the image sequence based on adaptive brightness compensation and LSF to obtain adjusted images, the dynamic image-block data processing sequentially comprising four steps: adaptive compensation of target points within image blocks, post-processing with Gaussian blur and adaptive-threshold binarization brightness compensation, LSF-based sub-pixel center localization of target points, and updating the image blocks while acquiring the target point centers of the image sequence;
a pose-calibration module, configured to perform camera-pose calibration on the adjusted images based on sliding-window constraints to obtain calibrated images, the camera-pose calibration sequentially comprising three steps: initial camera-pose estimation using the EPnP algorithm, optimization to minimize the re-projection error, and inter-sequence adjustment within the sliding window; and
a measurement-output module, configured to acquire 3D coordinates and estimated displacements of tracking points from the calibrated images, and to output measurement results based on the 3D coordinates and the estimated displacements.
